(19) United States
(12) Patent Application Publication
(10) Pub. No.: US 2020/0115960 A1
(43) Pub. Date: Apr. 16, 2020

(54) LADDER BASE SUPPORT SYSTEM

(71) Applicant: DAVID HOCH, FRIDLEY, MN (US)

(72) Inventor: DAVID HOCH, FRIDLEY, MN (US)

(21) Appl. No.: 16/158,207

(22) Filed: Oct. 11, 2018

(51) Int. Cl. E06C 7/46

(52) U.S. Cl. CPC E06C 7/46

(57) ABSTRACT

The present invention provides a system for operably adapting a ladder wherein such adaptation provides a stable base for almost any terrain, providing for a ladder that will substantially not slip from the base in use.

### BACKGROUND

Ladder use is necessary for the many and various jobs and needs that cannot be done from the ground. Jobs and activities such as painting, roof work or other assignments that fire fighters and roof gutter installers and cleaners require use of ladders, for the most part. The use of ladders also portends some safety issues as each year hundreds die and many thousands are injured from falling or other mishaps due to use of unstable ladders. Many fixes have been invented and incorporated into ladders and other contraptions have been utilized to address the concern of unneeded displacement and falls when ladders give up or slip from unstable footing on the ground. In some instances, devices provided for stability of the ladder may require climbing or ascending the ladder to install such device, which by that process makes for an unsafe environment and may violate Occupational Safety and Health Administration (OSHA) regulations.

The use of add-ons have a common concern that these add-ons may somehow obstruct or interfere with the normal use of a ladder. Also, any adaptation of a ladder that may cause unsafe conditions in the use of a ladder defeats the purpose of such adaptation and this has limited the incorporation of other fixes to the challenge of presenting an effective ladder for its intended use without additional unsafe fixes.

In an earlier disclosure of weighted bags was disclosed by David Hoch in Application No. 62/545,545.

From the foregoing and more, it will be appreciated that what is needed in the art is a system or fix that allows the use of a ladder without increasing the risk of slipping or making the ladder unsafe in any manner for its intended use or purpose. Such system is disclosed and claimed herein.

### SUMMARY

In one embodiment, the present invention provides a system for operably adapting a ladder base wherein such adaptation provides a stable base for almost any terrain, providing for a ladder that will substantially not slip from the base in use.

An embodiment of the present invention provides a Tillable sack or pouch having a strap that is preferably sown, woven or adhered to at least a middle portion of the sack, using a latching mechanism that is preferably securely attached to the bottom or a ladder, wherein such sack is filled with weighty material such as sand, crushed rock, cement or the like.

In another embodiment of the present invention, the system provides a means to weigh down a tent or other erection for a temporary use wherein such use of the adaptation provides a tent or such erection that is suitable for its safely intended purpose.

The present invention provides a method for holding down a canopy or tent or ladder using a filled bag that is preferably strapped to the bottom of the ladder or tent pole and wherein the filled bag is adaptable to the surface of application.

### BRIEF DESCRIPTION OF THE DRAWINGS

FIG. 1 illustrates a completed and filled sack for use as a ladder weight according to the present invention.

FIG. 2 illustrates a filled sack in use as a ladder weight according to the present invention.

FIG. 3 illustrates another perspective view of the sack in use as a ladder weight according to the present invention.

FIG. 4 illustrates another perspective view of the sack in use as a ladder weight according to the present invention.

### DETAILED DESCRIPTION

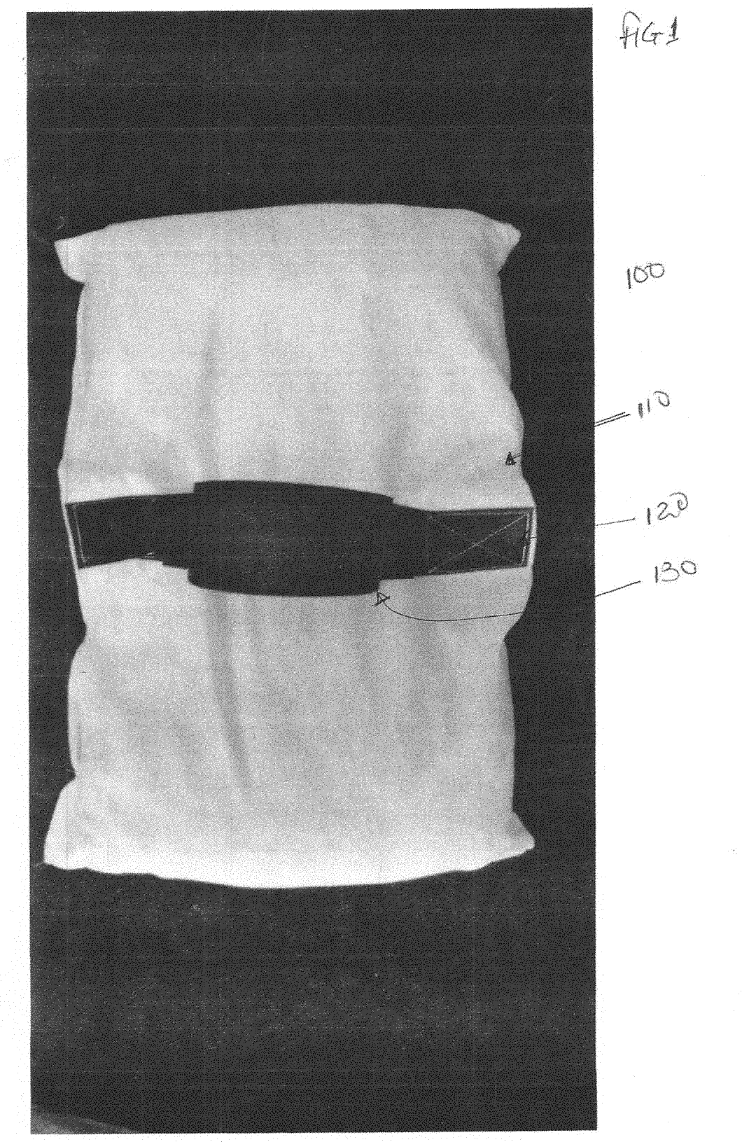

Referring to FIG. 1, a sack, bag or pouch 110 is provided in accordance with the present invention wherein said bag or pouch is filled with weighty material for latching or linked placement about a lower end or bottom leg of a ladder. In accordance with the present invention, the sack 110 is preferably filled with weighty material that may include but is not limited to sand, crushed rock, cement, or such other material that may suitably provide weight and be dense enough to fit into the pouch 110 for use as a ladder weight or support. The sack 110 of the present invention is preferably provided from material that can be sturdy enough to hold the selected filler material such as canvas, burlap with liner, reinforced plastics, or the like. Other qualities of the sack 110 of the present invention may include capabilities to repel water or moisture, be visible such as fluorescent or bright colors, adaptable enough to permanently attach a strap 120 or other such adaptable latching mechanism for use to attach to the lower end or bottom of a ladder. It is reasonable to expect other properties for the sack 110 such as weatherability, rain repellant qualities, sturdiness, puncture resistance, and the like. The strap 120 usable in the present invention preferably includes a latching portion 130 that is suitably provided for latching on to the bottom of a ladder.

The present invention provides a system for providing a safe and sturdy support for a ladder for use on substantially any surface without the risk or concern for shifting, slippage or unintended movement that may cause unintended falls for the user of the ladder. The ladder weight 100 of the present invention is preferable weighty enough to rest on the surface and serve as a continuous downward hold for the ladder when in use.

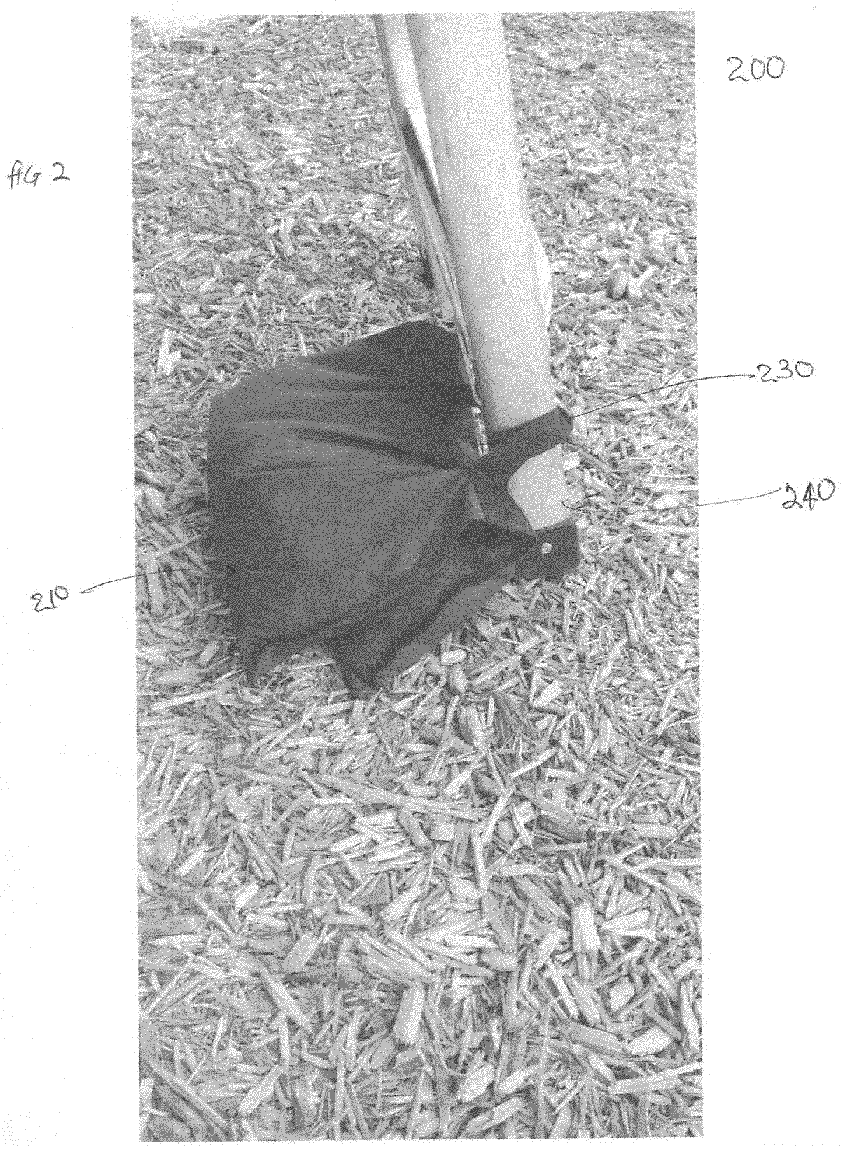

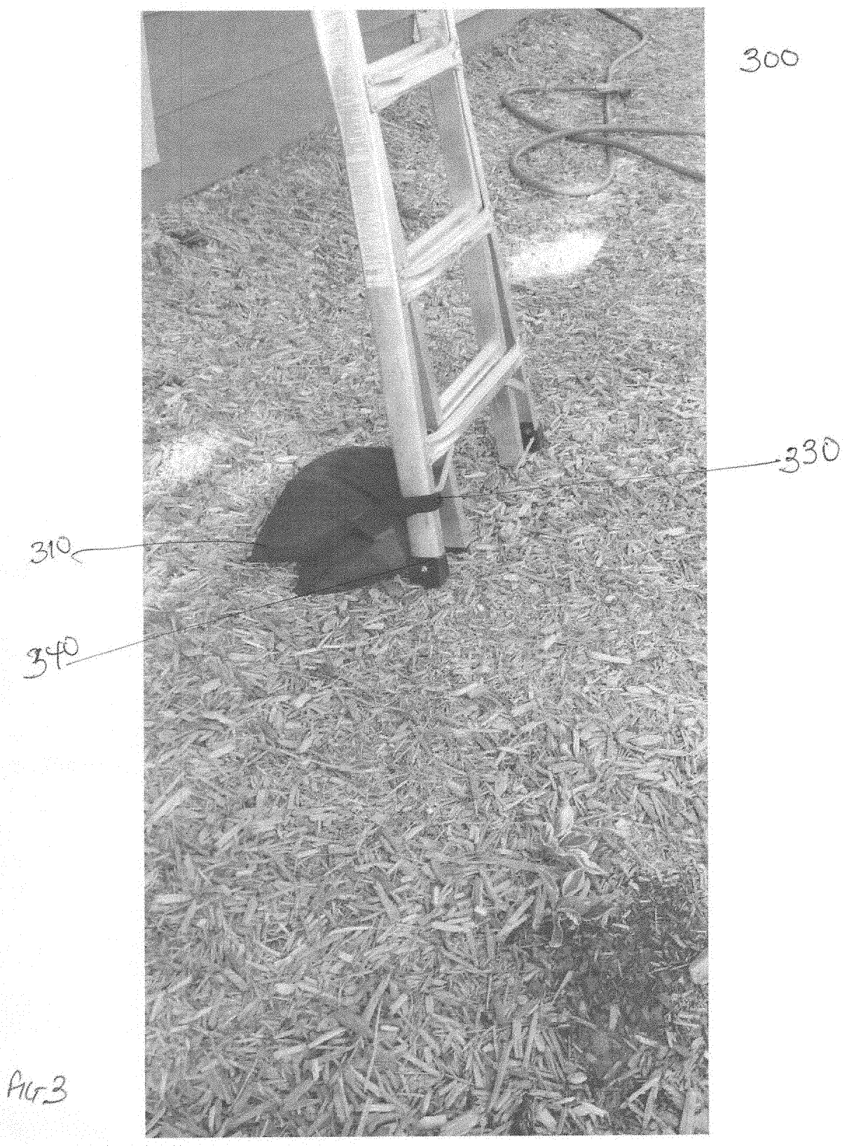

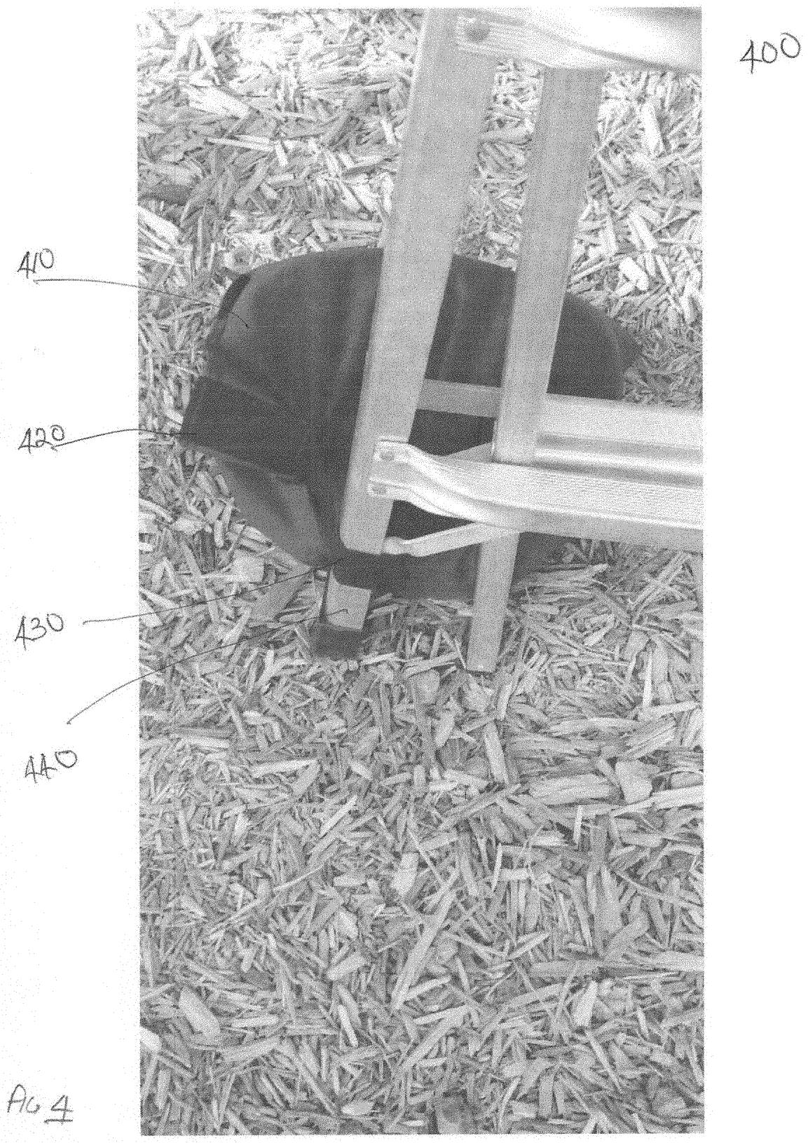

FIGS. 2-4 display various perspectives of the pouch 210, 310, 410 wherein the pouch is folded over at the middle and using the strap 220, 320, 420 having an outward latching portion 230, 330, 430 suitably and operably latched to one end or leg of a ladder 240, 340, 440. As shown in the provided figures and without limitation, the fold over of the pouch provides adequate weight with suitability of space for use of the ladder weight, providing sturdiness and non-slip functionality to the ladder in use. Most ladders have stubs at the bottom to provide grip to the surface as the ladders are in use, but the prevalence of accidents and slips acknowledge the need to provide added resource for the needed stability preventing accidents. A preferred process shows the bags or pouches 210, 310, 410 filled with weighty material as indicated above when in use. A spread of the filler to the ends of the pouch allows for the folding or doubling over of the bag for use. The bag or pouch is preferably latched by means of an interlocking strap and formed to the surface or terrain making for a stable ladder suitable to prevent slippage or untimely displacement or dislocation. In a present embodiment, a canvas pack is provided for use with a ladder to maintain stability of the ladder when in use. In this disclosure, a canvas pack may be a bag made of canvas or similarly functioning material suitable to be filled with sand or other filler material that meet the weight and other qualities of a pack for the invention.

The pack, bag or pouch 110, 210, 310, 410 of the present invention is preferably designed to rest on the ground (floor) and formed to adopt the terrain wherein such ladder is used. A typical filler material for the pack or bag is sand or other similarly suitable material that may not clump or is loose enough to take the shape of the location in use. As an example, if the pack or bag is placed on a rocky surface, the sand in the bag would preferably and readily form around the uneven surface to rest on the floor and prevent slippage. The pack or bag 110, 210, 310, 410 of the present invention may preferably include a strap that may be sewn or woven into the bag. The strap is preferably of such sturdiness to allow for usage as a handle to tote the bag. The strap 130, 230, 330, 430 used in the present invention preferably includes an interlocking mechanism such as locking strap or other such locking system to latch the bag, pack or a pouch to the bottom of the ladder. It is notable that any strap or connecting mechanism used for the bag or pouch 110, 210, 310, 410 of the present invention shall be suitable for the needed portability and toting around that may be necessary when in use.

In a preferred use, at least a bag or pouch 110, 210, 310, 410 is latched to preferably the bottom leg of the ladder, in a process or manner specifically to not interfere with the use of the ladder in the ascending or descending process. For the balancing process, two bags of similar weight are preferred for each ladder stability and use. In a typical formation, each sack may be filled with sand or other suitable filler material to a weight that provides adequate stability to the ladder. In an instance, a bag is filled to a weight that allows for average portability. Preferably, a bag may have at least about 20 pounds of sand, more preferably at least about 30 pounds of sand and most preferably at least about 35 pounds the sand or suitable filler material. It is practical to fill and use a bag that is much heavier than disclosed, such filling and use depending on the portability practicality of such packaging, the substrate to which it would be put or other factors as appropriate for use of the sack of the present invention.

The dimensions of the bag or pouch of the present invention is preferably such that when in use, it does not obstruct or otherwise interfere with the normal and usual use of the ladder. As an example, a bag may be made about at least 900 cubic inches, more preferably about 960 cubic inches and most preferably about 930 cubic inches. It is reasonable to impress that the size of the bag is geared toward the needed weight to meet the intended use. Specifically, the bag size may be bigger or smaller as long as it provides enough space for the required amount of filler sand or material. A bag having dimensions of about 20″×16″×3″ can be functional for use a ladder weight.

A user may preferably use an interlocking strap such as, Velcro®, Sotchlock® or similar locking mechanism on the bag wherein during placement, it is unlocked and locked about the bottom of the ladder on each side. After use, the interlocking mechanism is released and the bag removed for storage, transportation or other portable application. The form-fitting provided by the sand-filled bag which preferably takes the form of the terrain wherein the ladder is used and the weight make for a ladder that is stable for its use without the concern of slippage or dislocation.

The use of an embodiment of the present invention does not require any adjustments to the ladder, needs no tools, mechanical applications nor assembly for its effectiveness. Further, the instant invention does not present any rung attachment or other potential hazards or obstruction for the user of the ladder with the stabilizing feature as disclosed herein. Placement of the bag or pouch of the present invention is preferable when used between the bottom of the ladder and the structure said ladder is leaned against as better illustrated in the Figures shown below, further impressing that such incorporation of the weight support system does not interfere with the use and safety of the ladder when in use.

In another embodiment of the present invention, a similarly filled bag or pouch may be latched or otherwise attached to the bottom of a tent stand to prevent such tent from displacement by the wind or elements when in use. In some instances, the use of said bag filled with sand or other suitable material may provide capacity to use a tent on hard surfaces without the need to dig a hole for the ends of the tent rod.

Camp or canopies may be made stable by use of the support system of the present invention. In an example, a pouch filled with weighty fillers may be strapped to at least a pole end of a canopy stand. The benefit of the present invention is that each filled pouch may be positioned and strapped to the pole end in a process that allows for the flexibility of an inside the tent stand or outside as appropriate to provide the sturdiness as needed to keep the canopy from being relocated by the elements such as heavy wind or rains.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed:

1. A ladder base support system, comprising:
a fillable sack, wherein said sack further comprises at least a strap rigidly attached at least one middle portion of the sack,
a latching mechanism incorporated into the strap wherein said latch provides capacity to securely attach to a bottom of a ladder, and further wherein the sack when filled with weighty fillers suitably provide optimized support for a ladder system to prevent untimely displacement.

2. The ladder base support system of claim 1, wherein the sack is made from tear-resistant material.

3. The ladder support system of claim 2, wherein the tear-resistant material is selected from canvas, burlap, reinforced plastic, or combinations thereof.

4. The ladder base support system of claim 2, wherein the sack is formed from material that has weatherability, rain repellant qualities, sturdiness, puncture resistance, and the like.

5. The ladder base support system of claim 1, wherein the strap is sown, woven or adhered to provide rigidity to the sack.

6. The ladder base support system of claim 1, wherein the strap is adhered to the sack suitably to allow for a fold over of the sack and exposure of the strapped side.

7. The ladder base support system of claim 1, wherein the sack is filled with weighty material such as sand, crushed rocks, cement or the like.

8. The ladder base support system of claim 1, wherein the sack is suitable for form-fitting to the substrate where it is placed.

9. A method of providing a ladder support system, comprising:
providing a fillable sack, wherein said sack further comprises at least a strap rigidly attached at least one middle portion of the sack,
providing a latching mechanism incorporated into the strap wherein said latch provides capacity to securely attach to a bottom of a ladder, and further wherein the sack when filled with weighty fillers suitably provide optimized support for a ladder system to prevent untimely displacement.

10. The method of claim 9, wherein the sack is made from tear-resistant material.

11. The method of claim 10, wherein the tear-resistant material is selected from canvas, burlap, reinforced plastic, or combinations thereof.

12. The method of claim 10, wherein the sack is formed from material that has weatherability, rain repellant qualities, sturdiness, puncture resistance, and the like.

13. The method of claim 9, wherein the strap is sown, woven or adhered to provide rigidity to the sack.

14. The method of claim 9, wherein the strap is adhered to the sack suitably to allow for a fold over of the sack and exposure of the strapped side.

15. The method of claim 9, wherein the sack is filled with weighty material such as sand, crushed rocks, cement or the like.

16. The method of claim 9, wherein the sack is filled with weighty material allowing for fold over and portability.

17. The method of claim 9, wherein the sack is placed away from a ladder rung.
